(19) United States
(12) Patent Application Publication
(10) Pub. No.: US 2025/0084741 A1
(43) Pub. Date: Mar. 13, 2025

(54) METHODS FOR HYDRAULIC FRACTURING

(71) Applicant: SCHLUMBERGER TECHNOLOGY CORPORATION, Sugar Land, TX (US)

(72) Inventors: Vadim Ismailovich ISAEV, Sugar Land, TX (US); Ivan Anatolyevich TSYGULEV, Moscow (RU); Ivan Vladimirovich VELOKANOV, Novosibirsk (RU); Fedor Nikolaevich LITVINETS, Novosibirsk (RU)

(21) Appl. No.: 18/718,224

(22) PCT Filed: Dec. 9, 2021
(86) PCT No.: PCT/RU2021/000561

§ 371 Date: Jun. 10, 2024

(51) Int. Cl. E21B 43/26; E21B 43/25

(52) U.S. Cl. CPC E21B 43/26; E21B 43/255; E21B 2200/20

(57) ABSTRACT

Hydraulic fracturing treatments are performed by injecting hydraulic fracturing materials into two or more perforation clusters. Treatment data concerning pressure, flow rate and properties of the hydraulic fracturing materials are recorded. These data are analyzed by one or more techniques for estimating cluster efficiency. The data may be entered into one or more computer models for hydraulic fracturing. The modeling results are compared to the treatment data. Or, the treatment data may be analyzed using one or more wellbore pressure-wave propagation models. These waves may be generated by pumps and other sources. The reflection times from hydraulic fractures provide additional information about their position. Or, the treatment data may be analyzed using one or more machine learning algorithms employing data from heterodyne distributed vibration sensing or other systems. The hydraulic fracturing treatment may be adjusted to improve perforation cluster efficiency. This procedure may be performed in real time.

### BACKGROUND

The statements in this section merely provide background information related to the present disclosure and may not constitute prior art.

For decades, the oil and gas industry has performed hydraulic fracturing to enhance or prolong well productivity. Without fracturing, producing from most hydrocarbon reservoirs being developed today would not be technically or economically feasible.

During a fracturing treatment, specialized equipment pumps fluid into a well faster than can be absorbed by the formation. This causes pressure on the formation to rise until the rock fractures, or breaks down. Continued pumping causes the fracture to propagate away from the wellbore, increasing the formation surface area from which hydrocarbons can flow into the wellbore. This helps the well achieve a higher production rate than would otherwise be possible. As a result, the volume of produced hydrocarbons increases dramatically, and operators recover their development investments more quickly.

Fracturing operations employ two principal substances-proppants and fracturing fluid. Proppants are particles that hold the fractures open, preserving the newly formed pathways. Fracturing fluids may be aqueous or nonaqueous and must be sufficiently viscous to create and propagate a fracture and also transport the proppant down the wellbore and into the fracture. Once the treatment ends, the fracturing fluid viscosity must decrease enough to promote its rapid and efficient evacuation from the well.

Traditional fracturing treatments consist of two fluids. The first fluid, or pad, does not contain proppant and is pumped through casing perforations at a rate and pressure sufficient to break down the formation and create a fracture. The second fluid, or proppant slurry, transports proppant through the perforations into the open fracture. When pumping ceases, the fractures close, holding the proppant pack in place, and the fracturing fluid flows back into the wellbore to make way for hydrocarbon production. Ideally, the proppant pack should be free of fluid residue that can impair conductivity and hydrocarbon production.

For more than 60 years, chemists and engineers have sought to develop fracturing fluids, proppants and placement techniques that help produce ideal propped fractures and maximize well productivity. As a result, the chemical and physical nature of the fluids has evolved significantly. The industry has introduced essentially residue-free fracturing fluids. Heterogeneous proppant packs have further maximized proppant pack conductivity, exemplified by the HiWAY® flow-channel hydraulic fracturing technique, available from Schlumberger.

Today's proppant packs pose little resistance to fluid flow. However, achieving optimal well productivity still requires that the fracturing fluid be able to enter all of the perforations, thereby allowing maximum wellbore access to the entire region to be stimulated. Failure to do so may leave a large fraction of the reservoir untouched and, consequently, large volumes of hydrocarbons inaccessible.

Treating all perforations is particularly challenging when stimulating unconventional shale formations. Most operators produce shale oil and gas from horizontal wellbores that may extend for hundreds of meters through the producing formation. Therefore, to ensure adequate stimulation, completion operations may include perforating the wellbore in “clusters” of multiple perforations. Traditionally, the clusters are arranged in an equidistant pattern. Such wells are called geometric completions. However, because shales are usually heterogeneous, engineers have begun using seismic and log data to determine formation mechanical properties and potential productivity along the wellbore. Operators then limit perforating and stimulation to potentially more productive areas, forming optimized perforation clusters. This approach usually reduces the number of stages and plugs, thereby lowering costs without sacrificing well productivity. These wells are called engineered completions.

Despite improvements realized by the optimized cluster technique, fracture initiation pressures within an interval may still be highly variable, leading to uneven stimulation among the perforation clusters. Perforations adjacent to low-fracture gradient rock may be preferentially stimulated, leaving those in more resistant rock untouched. When conventional fracturing techniques are employed, up to 40% of the perforations may fail to contribute to production.

Thus, although treating multiple perforation clusters reduces operational time cost, there is uncertainty concerning the number of clusters that have been stimulated (i.e. “cluster efficiency”). It would be useful if operators had methods for determining cluster efficiency during a treatment, thereby allowing adjustment of the treatment.

### SUMMARY

The present disclosure proposes methods for determining and improving cluster efficiency during a hydraulic fracturing treatment.

In an aspect, embodiments relate to hydraulic fracturing methods. A hydraulic fracturing treatment is performed by injecting fracturing materials into two or more perforation clusters. The hydraulic fracturing treatment is monitored by recording data concerning pressure and the properties of the hydraulic fracturing materials in the wellbore. The recorded data are analyzed to estimate perforation cluster efficiency. The hydraulic fracturing treatment is adjusted to improve perforation cluster efficiency.

### BRIEF DESCRIPTION OF THE DRAWINGS

FIG. 1 is a schematic view of a wellbore containing five perforation clusters.

FIG. 2 shows the minimum horizontal stresses along the horizontal wellbore and the five perforation clusters.

FIG. 3 shows the evolution of bottomhole pressure during treatments during which 2, 3, 4 and 5 perforation clusters are stimulated.

FIG. 4 shows a scenario during which only one perforation cluster was stimulated efficiently.

FIG. 5 shows the results of adjusting the treatment schedule. All five perforation clusters were stimulated efficiently.

FIG. 6 shows simulated reflection depths and confidence levels during a multistage fracturing treatment.

FIG. 7 is a plot showing the use of a machine learning algorithm to estimate cluster efficiency by considering treating pressure, injection rate and proppant concentration.

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation-specific decisions are made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the disclosure and this detailed description, each numerical value should be read once as modified by the term “about” (unless already expressly so modified), and then read again as not so modified unless otherwise indicated in context. The term about should be understood as any amount or range within 10% of the recited amount or range (for example, a range from about 1 to about 10 encompasses a range from 0.9 to 11). Also, in the summary and this detailed description, it should be understood that a concentration range listed or described as being useful, suitable, or the like, is intended that any concentration within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, even if specific data points within the range, or even no data points within the range, are explicitly identified or refer to a few specific, it is to be understood that inventors appreciate and understand that any data points within the range are to be considered to have been specified, and that inventors possessed knowledge of the entire range and the points within the range.

As used herein, “embodiments” refers to non-limiting examples disclosed herein, whether claimed or not, which may be employed or present alone or in any combination or permutation with one or more other embodiments. Each embodiment disclosed herein should be regarded both as an added feature to be used with one or more other embodiments, as well as an alternative to be used separately or in lieu of one or more other embodiments. It should be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

Moreover, the schematic illustrations and descriptions provided herein are understood to be examples only, and components and operations may be combined or divided, and added or removed, as well as re-ordered in whole or part, unless stated explicitly to the contrary herein. Certain operations illustrated may be implemented by a computer executing a computer program product on a computer readable medium, where the computer program comprises instructions causing the computer to execute one or more of the operations, or to issue commands to other devices to execute one or more of the operations.

Numerous methods have been presented in the industry for optimizing perforation cluster design during multistage hydraulic fracturing. An example is presented in the following publication.

Settgast R R et al.: “Optimized Cluster Design in Hydraulic Fracture Stimulation,” paper URTEC-2172691-MS, presented at the SPE/AAPG/SEG Unconventional Resources Technology Conference, San Antonio, TX, USA, July 2015.

However, there is a lack of methods for monitoring and controlling the number of perforation clusters with a nonzero inflow of hydraulic fracturing materials. The present disclosure proposes methods for determining and improving cluster efficiency during a hydraulic fracturing treatment. It is monitored by recording data concerning pressure, flow rate, proppant concentration, and the properties of the hydraulic fracturing materials in the wellbore. These data are analyzed using one or more methods comprising comparison with hydraulic fracturing models, analysis of reflection times of pressure waves in the wellbore, and one or more machine learning algorithms.

In an aspect, embodiments relate to hydraulic fracturing methods. A hydraulic fracturing treatment is performed by injecting fracturing materials into two or more perforation clusters. The hydraulic fracturing materials may be injected homogeneously or during more than one stage. The hydraulic fracturing materials may also be injected in pulses, in a manner exemplified by HiWAY® flow-channel fracturing treatments, available from Schlumberger. The hydraulic fracturing treatment is monitored by recording data concerning pressure and the properties of the hydraulic fracturing materials in the wellbore. The recorded data are analyzed to estimate perforation cluster efficiency. The hydraulic fracturing treatment is adjusted to improve perforation cluster efficiency. The adjusting may comprise changing the pumping rate, the concentrations of hydraulic fracturing materials, or both.

During a hydraulic fracturing treatment, gauges may be installed at the surface to monitor pressure, the slurry density of the hydraulic fracturing materials, volumetric flow rate, and the concentrations of the hydraulic fracturing materials. The hydraulic fracturing fluids may comprise fluids (e.g., water or brine), proppants and additives. The additives may comprise fibers, fluid-loss additives, diverting agents, breakers, corrosion inhibitors, friction reducers, scale inhibitors, surfactants, water soluble polymers, crosslinkers, biocides, pH adjusting agents (e.g., acids or bases) or buffers, or combinations thereof. Bottomhole gauges may also be installed to monitor pressure.

To estimate cluster efficiency, one or more hydraulic fracturing models may be used to analyze possible scenarios with one or more stimulated perforation clusters. Bottomhole and surface pressures may be compared to the models calculated in the model with the data from the gauges, allowing detection of the scenarios with the best agreement with the measured data. The modeling provides gives an estimate of the number of stimulated perforation clusters.

One of more hydraulic fracturing computer models may be used during the performance of the disclosed methods. In the disclosed methods, the modeling is performed for different sets of perforation clusters with a nonzero inflow of the hydraulic fracturing materials. Data acquired during the fracturing treatment may be entered into the computer models, and the modeling results may be compared to the data.

The PKN and KGD computer models consider a constant fracture height, and assumes that rock deformation occurs in one plane of the hydraulic fracture. These models are described in the following publications. Perkins T K et al.: “Widths of Hydraulic Fractures,” Journal of Petroleum Technology, 13 (1961), 9, SPE-89-A. Geertsma J and De Klerk F: “A Rapid Method of Predicting Width and Extent of Hydraulically Induced Fractures,” Journal of Petroleum Technology, 21 (1969) 12.

A radial model considers axisymmetric deformation of rock relative to the well axis, and assumes the rock is isotropic. This model is described in the following publication. Barenblatt G: “On the formation of horizontal cracks in hydraulic fracture of an oil-bearing stratum,” Prikl. Mat. Mech. 20, 475-486 (1956).

A pseudo-three-dimensional model (Pseudo 3D) considers a planar vertical fracture of variable height presented in the form of cells like the PKN model. Widely used in the oil and gas industry, it is applicable when the fracture half-length significantly exceeds its height. This model is available as FracCADE, available from Schlumberger.

A planar three-dimensional model (Planar 3D) considers a vertical fracture of variable height with any length-to-height ratio. It may be more accurate than the pseudo-3D in cases when the reservoir consists of several layers with significantly varying properties (e.g., minimum horizontal compressive stress, Young's modulus, etc.). This model is described in the following publication. U.S. Pat. No. 6,876,959: “Method and Apparatus for Hydraulic Fractioning Analysis and Design” 2005. This approach is available in the following commercial models: GOHFER® (HALLIBURTON ENERGY SERVICES, INC), TerraFrac (Terra-Tek), STIMPLAN® (NSI) and RN-GRID (Rosneft).

Another 3D model considers a curved fracture trajectory with arbitrary directions of propagation, none of which are in the same plane. This model is described in the following publication. Alekseenko O et al.: “3D Modeling of Fracture Initiation from Perforated Noncemented Wellbore,” paper SPE-151585-PA (2013).

Another pseudo-3D model considers naturally fractured reservoirs. A hydraulic fracture that was created meets an existing natural fracture and subsequent development of the fracture network is described by a specially built geomechanical model (geomechanics for intersecting fractures). The model is available from Schlumberger as UFM®. U.S. Pat. No. 8,412,500.

Additionally, machine learning algorithms may be trained to predict the distribution of inflow fluxes into perforation clusters using data from the gauges listed above.

Comparing the data to the modeling results may be used to detect stimulated perforation clusters.

Additionally, the analysis may be further based on pressure waves (aka “tube waves”) in the wellbore provided the data have a frequency higher than 1 Hz. This may provide another estimate of the distribution of inflow fluxes into perforation clusters.

Finally, if some of the clusters are not stimulated, the treatment design may be adjusted by changing the pump rate, concentrations of the hydraulic fracturing materials, or both. Such adjustments may be performed in real time.

### Examples

### Example 1—Estimation of Number of Stimulated Clusters Using Analysis of Bottomhole Pressure

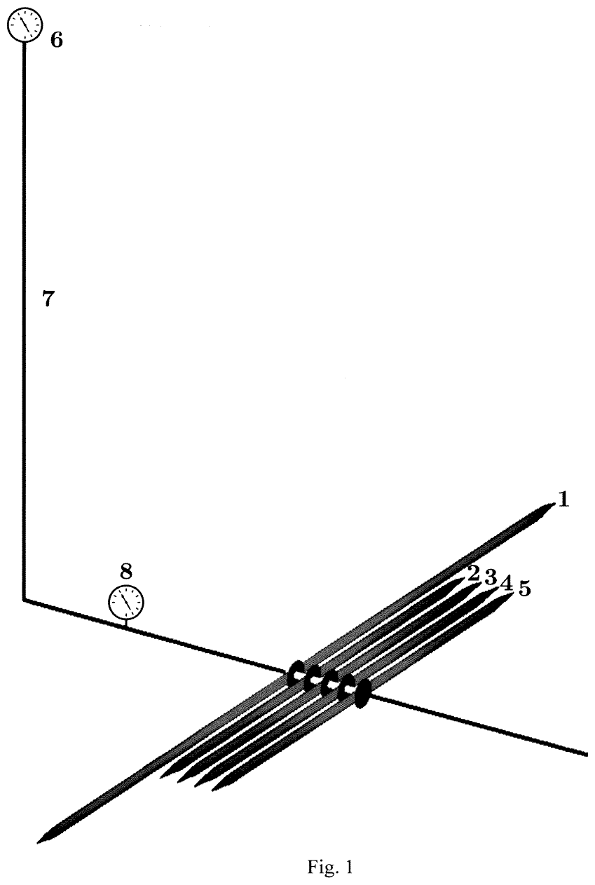

A hydraulic fracturing treatment with five perforation clusters (1-5) in a horizontal wellbore is considered (FIG. 1). Surface gauges 6 and bottomhole gauges 8 are installed along the wellbore 7. The pumping schedule is shown in Table 1.

TABLE 1
Pumping Schedule.

| | Pump | | Fluid | | Prop. | Pump |
|---|---|---|---|---|---|---|
| | rate, | | volume, | Proppant, | conc, | time, |
| Step # | bbl/min | Fluid | gal | mesh size | ppa* | min |
| 1 | 10 | Slickwater | 3000 | None | 0 | 7.14 |
| 2 | 10 | Slickwater | 3000 | None | 0 | 7.14 |
| 3 | 10 | Slickwater | 2000 | Sand 70/140 | 0.25 | 4.82 |
| 4 | 10 | Slickwater | 2000 | Sand 70/140 | 0.5 | 4.87 |
| 5 | 10 | Slickwater | 2000 | Sand 70/140 | 0.75 | 4.92 |
| 6 | 10 | Slickwater | 2000 | Sand 70/140 | 1 | 4.98 |
| 7 | 10 | Slickwater | 2000 | Sand 70/140 | 1.25 | 5.03 |
| 8 | 10 | Linear gel | 3000 | Sand 40/70 | 1.5 | 7.63 |
| 9 | 10 | Linear gel | 3000 | Sand 40/70 | 1.75 | 7.71 |
| 10 | 10 | Linear gel | 3000 | Sand 40/70 | 2 | 7.79 |
| 11 | 10 | Linear gel | 3000 | Sand 40/70 | 2.25 | 7.87 |
| 12 | 10 | Linear gel | 3000 | Sand 40/70 | 2.5 | 7.95 |
| 13 | 10 | Linear gel | 3000 | Sand 40/70 | 2.75 | 8.03 |
| 14 | 10 | Linear gel | 3000 | Sand 40/70 | 3 | 8.12 |

*ppa = pounds of proppant per gallon added

Slickwater is a Newtonian fluid with a viscosity of 0.5 cP. Linear gel is a guar-base power-law fluid with consistency and behavior indices of 0.034 Pa-s and 0.8, respectively. The guar concentration was 20 lbm/gal (2.4 kg/L)

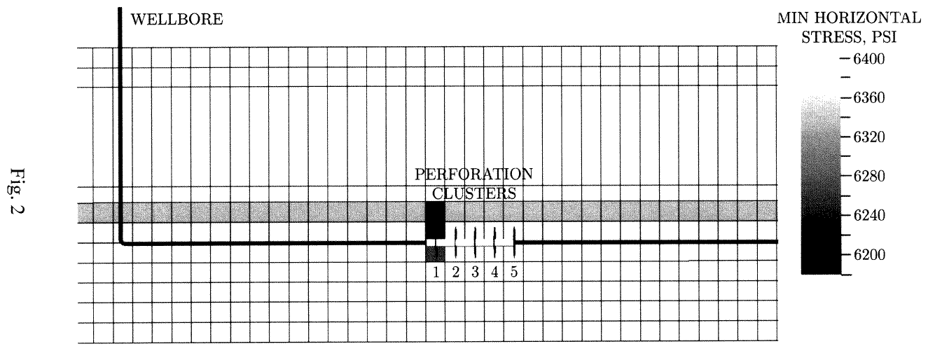

The reservoir zones have different minimal principal horizontal stresses near the clusters (FIG. 2). The Young's modulus is constant for all zones (4.5 Mpsi). The first cluster has lower stresses; therefore, it should receive more inflow than the others. However, it is desired to stimulate all clusters uniformly.

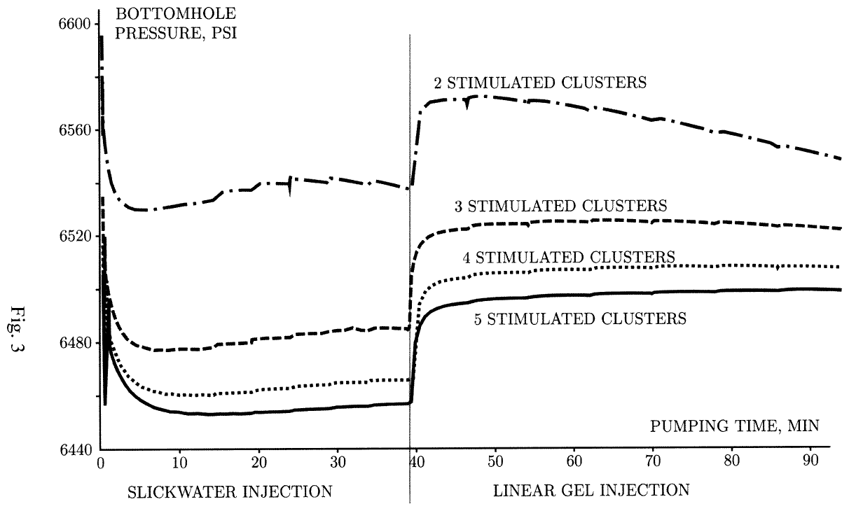

FIG. 3 demonstrates bottomhole pressures calculated by the Planar 3D hydraulic fracturing model for different numbers of stimulated clusters: clusters 4 and 5 only (2 stimulated clusters); clusters 3, 4 and 5 only (three stimulated clusters); clusters 2, 3, 4 and 5 (4 stimulated clusters); and all 5 clusters stimulated.

In these simulations, different possible scenarios were considered, including those where some clusters were not stimulated due to increased flow resistance caused by near-wellbore tortuosity, phasing misalignment, perforation friction, etc. A noticeable bottomhole-pressure difference was seen in these cases (e.g., 50 psi between 2 and 3 stimulated clusters). Comparison of measured bottomhole pressures with the calculated data provides information about the scenarios occurring during actual treatments.

### Example 2—Adjustment of Treatment Design for Cluster Efficiency Control

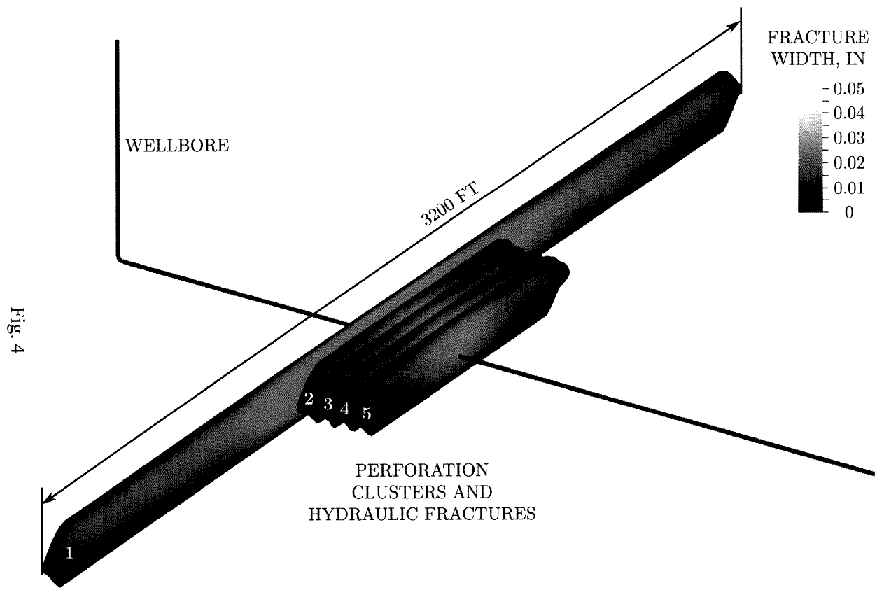

FIG. 4 shows calculated fracture geometries for five stimulated clusters at the end of the pumping time: width distribution, length, height, and shape. The fracture in Cluster 1 is three times longer than the others. A major part of the slurry volume flows to the first cluster, and the remaining clusters were not stimulated efficiently.

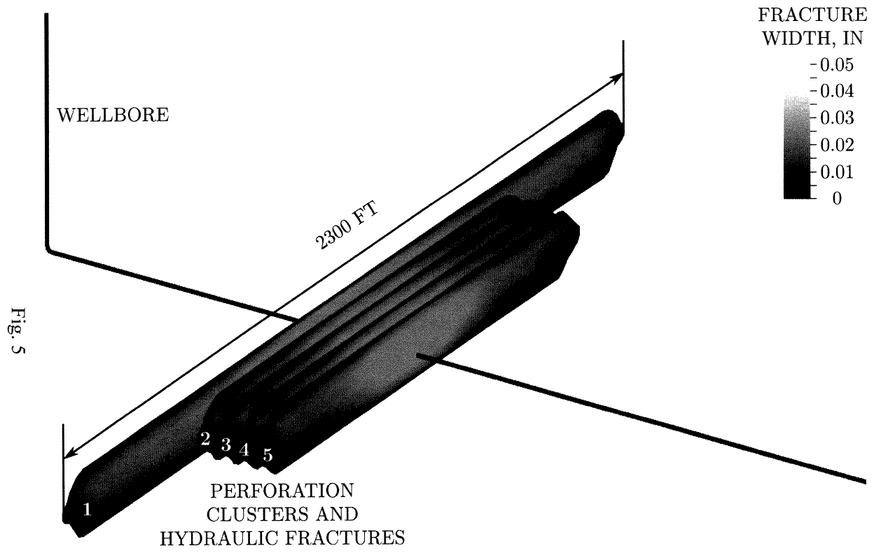

The differences between the fracture geometries appeared during the first stage of the pumping schedule. Thus, it was monitored during the treatment. To improve stimulation efficiency, the treatment design was adjusted by increasing the pumping rate to 20 bbl/min during Stages 2-14 (Table 1). FIG. 5 shows the simulation results for the new pumping schedule. It is seen that the adjusted treatment design improved stimulation efficiency for the remaining clusters 2-5.

### Example 3—Pressure Waves

Cepstral analysis of the wellhead pressure data (described in U.S. Pat. No. 11,035,223 B2) provides the reflection times required for pressure waves generated by pumps and other sources to travel back and forth along the wellbore from the wellhead to the hydraulic fractures.

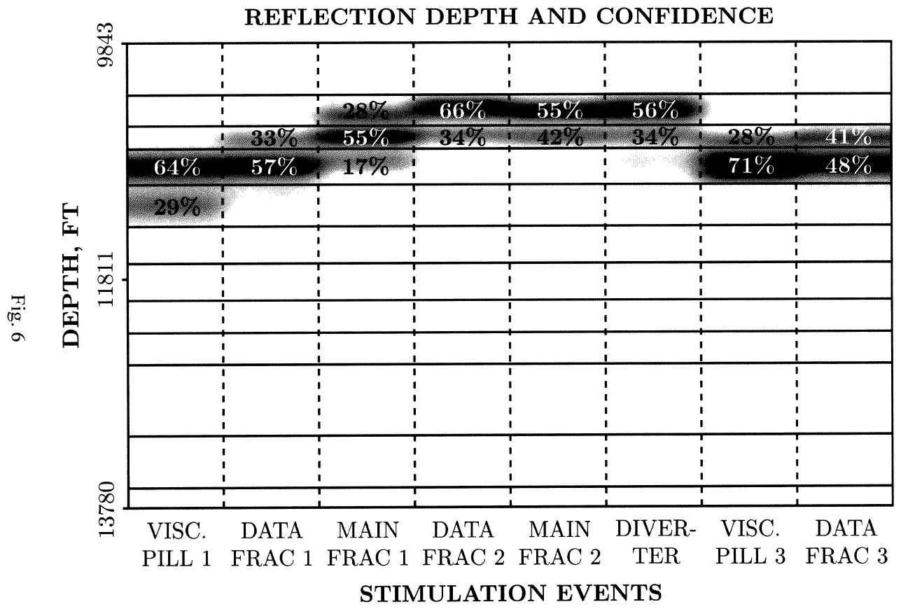

When multiple stages are stimulated, the pressure-wave propagation speed may be estimated iteratively using the reflection times at different stages and interval depths (potential fracture locations). Finally, this analysis provides the reflection depth with its confidence calculated based on the consistency of estimations performed for different stages. FIG. 6 shows an example of such analysis providing information about stimulated perforation clusters. Here, the treatment was performed in a horizontal wellbore with perforation clusters located at a depth between 9800 and 13,800 ft. The pumping rate was from 3 to 9 bbl/min for the viscous pill and 25 bbl/min during the other stimulation events. The treating pressure was 400 bar. The same borate crosslinked guar-base gel with an initial viscosity of 1100 cP was pumped for all stimulation events. The guar concentration was 50 lbm/1000 gal (6 g/L). Proppant was injected during Main Frac 1 and Main Frac 2 only. The pumping times were 5 min, 30 min, and 90 min for Viscous Pill 1, DataFRAC 1-3, and Main Frac 1-3, respectively. The DataFRAC service is available from Schlumberger, and comprises a closure test that determines closure pressure or the minimum in situ rock stress. The service also comprises a calibration test that is an injection/shut-in/decline procedure. A viscosified fluid without proppant is pumped into the well at a rate proposed for the fracturing treatment. The well is then shut in and the pressure decline is monitored and analyzed using FracCADE fracturing design and evaluation software (available from Schlumberger).

### Example 4—Machine Learning

For given distribution of inflow rates q₁, . . . , q_{N} entering N perforation clusters the stimulation efficiency can be described by cluster efficiency indicator n defined as:

$$η = 1 - \frac{{σ}_{N}}{\sqrt{N} {\overline{q}}_{N}} ,$$

$${\overline{q}}_{N} = \frac{1}{N} {\sum }_{i = 1}^{N} {q}_{i} ,$$

$${σ}_{N}^{2} = \frac{1}{N - 1} {\sum }_{i = 1}^{N} {( {q}_{i} - {\overline{q}}_{N} )}^{2} .$$

In the case of high stimulation efficiency, the flow is distributed almost uniformly along all clusters and η tends to 1. When some clusters have small inflow compared to others quantity η decreases.

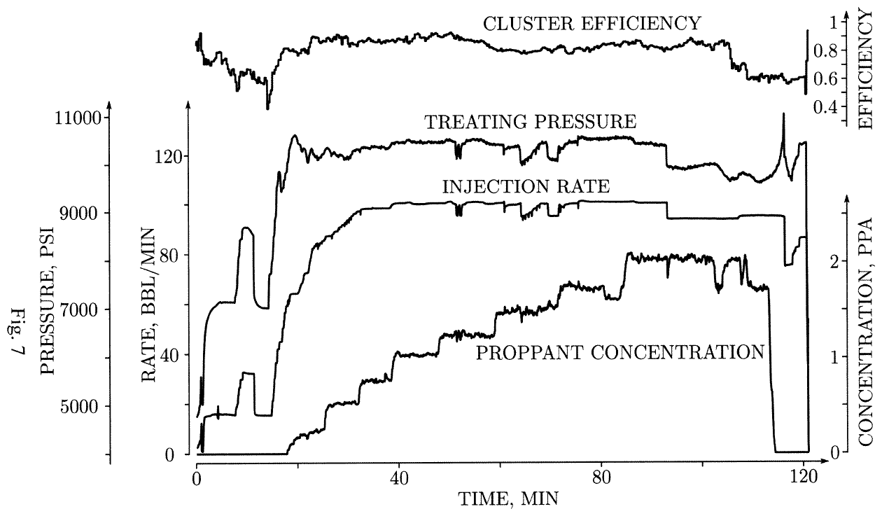

The calculation of cluster efficiencies from given data (pressure, rate and proppant concentration) is a regression problem that can be solved by one or more machine learning algorithms such as linear regression, ridge regression, neural network regression, lasso regression, decision tree regression, random forest, support vector machines and others. The machine learning algorithms can be trained on benchmark data provided by heterodyne distributed vibration sensing, representing actual inflow into stimulated perforation clusters. FIG. 7 shows an example wherein the cluster efficiency is calculated using a convolutional neural network applied to wellhead data acquired during simultaneous treatment of multiple perforation clusters.

The preceding description has been presented with reference to present embodiments. Persons skilled in the art and technology to which this disclosure pertains will appreciate that alterations and changes in the described structures and methods of operation can be practiced without meaningfully departing from the principle, and scope of this present disclosure. Accordingly, the foregoing description should not be read as pertaining only to the precise structures described and shown in the accompanying drawings, but rather should be read as consistent with and as support for the following claims, which are to have their fullest and fairest scope.

1. A method of hydraulic fracturing, comprising:
a. performing a hydraulic fracturing treatment by injecting hydraulic fracturing materials into two or more perforation clusters;
b. monitoring the hydraulic fracturing treatment by recording data concerning pressure and properties of the fracturing materials in a wellbore;
c. analyzing the data from stage (b) to estimate perforation cluster efficiency;
d. adjusting the hydraulic fracturing treatment to improve the perforation cluster efficiency.

2. The method of claim 1, wherein the pressure data are measured at a wellhead or a bottomhole or both.

3. The method of claim 2, wherein the pressure data arise from pressure waves having a frequency higher than 1 Hz.

4. The method of claim 1, wherein the monitoring further comprises measuring volumetric flow rate, slurry density and hydraulic fracturing material concentrations at a wellhead.

5. The method of claim 1, wherein the data analysis at stage (c) comprises entering the data from stage (b) into one or more computer models for hydraulic fracturing and comparing modeling results with the data from stage (b).

6. The method of claim 5, wherein the one or more computer models comprise PKN, KGD, radial, Pseudo 3D or Planar 3D models, or combinations thereof.

7. The method of claim 5, wherein the modeling is performed for different sets of perforation clusters with nonzero inflow of the hydraulic fracturing materials.

8. The method of claim 5, wherein the comparing of modeling results is used to detect stimulated perforation clusters.

9. The method of claim 1, wherein the data analysis at stage (c) comprises calculation of hydraulic fracture depth based on reflection times for pressure waves travelling in the wellbore.

10. The method of claim 1, wherein the data analysis at stage (c) comprises calculation of the cluster efficiency based on one or more machine learning algorithms.

11. The method of claim 10, wherein the one or more machine learning algorithms address the data acquired at stage (b) and heterodyne distributed vibration sensing data.

12. The method of claim 10, wherein the one or more machine learning algorithms comprise linear regression, ridge regression, neural network regression, lasso regression, decision tree regression, random forest or support vector machines, or combinations thereof.

13. The method of claim 1, wherein the hydraulic fracturing materials comprise fluids, proppants and additives.

14. The method of claim 13, wherein the additives comprise fibers, fluid-loss additives, diverting agents, breakers, corrosion inhibitors, friction reducers, scale inhibitors, surfactants, water soluble polymers, crosslinkers, biocides, pH adjusting agents or buffers, or combinations thereof.

15. The method of claim 1, wherein the adjusting of the hydraulic fracturing treatment comprises changing a pumping rate, concentrations of the hydraulic fracturing materials or both.

16. The method of claim 1, wherein the adjusting of the hydraulic fracturing treatment is performed in real time.

17. The method of claim 1, wherein stage (a) comprises more than one stage.

18. The method of claim 1, wherein the hydraulic fracturing materials are injected in pulses during one or more stages at stage (a).

19. The method of claim 1, wherein the hydraulic fracturing materials are injected homogeneously at stage (a).
